(19) United States
(12) Patent Application Publication
(10) Pub. No.: US 2025/0003840 A1
(43) Pub. Date: Jan. 2, 2025

(54) BLIND HOLE REMOTE SAMPLING POINT FOR A PARTICLE DETECTOR

(71) Applicant: ROCKWELL RESEARCH AND DEVELOPMENT GROUP, LLC, Portland, OR (US)

(72) Inventor: Steven William `Joseph, Portland, OR (US)

(21) Appl. No.: 18/758,731

(22) Filed: Jun. 28, 2024

Related U.S. Application Data
(60) Provisional application No. 63/510,742, filed on Jun. 28, 2023.
(60) Provisional application No. 63/510,764, filed on Jun. 28, 2023.
(60) Provisional application No. 63/511,662, filed on Jul. 2, 2023.

(51) Int. Cl. G01N 1/22

(52) U.S. Cl. CPC G01N 1/2247

(57) ABSTRACT

A blind hole remote sampling point for a particle detector is an all in one remote sample point with integrated RFID technology for storage of data relevant to the remote sample point. It is comprised of two parts to form a compression fit eliminating the need of secondary hardware, making it suitable for practically any mounting structure thickness and blind holes where access to the backside of a mounting structure is inaccessible. The integrated RFID chip permanently stores information electronically.

### RELATED APPLICATIONS

This application claims the benefit of and priority to U.S. Provisional Application No. 63/510,742, filed on Jun. 28, 2023, U.S. Provisional Patent Application No. 63/510,764 filed on Jun. 28, 2023, and U.S. Provisional Patent Application No. 63/511,662 filed on Jul. 2, 2023, the entire contents of each are incorporated herein by reference.

### TECHNICAL FIELD

The present disclosure is directed to blind hole remote sampling points for particle detectors.

### BACKGROUND

Remote sampling points currently on the market used with particle detectors, such as aspirating smoke detectors, have challenges and limitations with respect to installation and removal in the various mounting structures they are intended to be attached to, such as a wall or ceiling. Most rely on some form of fastener or anchor to contact the back side of the mounting structure which then limits their application to specified mounting structure thickness. Some require access to the back side of the mounting structure making them unsuitable for blind hole application. Some are one-way insertion that either compress into a receiving hole in the mounting structure or use the back side of the mounting structure to anchor in place, meaning once inserted they cannot be removed without causing damage to the sampling point or the mounting structure. Others rely on the use of fasteners from the face of the sampling point for anchoring into the surface area of a mounting structure which may not be aesthetically pleasing and requires additional hardware and labor to facilitate installation. They are also unequipped with a means to electronically store and append data relevant to their configuration, performance, or communicate wirelessly with external readers.

### SUMMARY

In accordance with embodiments of the present disclosure, a blind hole remote sampling point apparatus is provided and is made up of a housing with a channel for fluid flow, a mounting retainer, a particulate air outlet, an air inlet and an RFID device. The sampling point housing mechanically couples to the retainer for mounting to a structure and the RFID device is configured to monitor performance characteristics of the blind hole remote sampling point. The mounting retainer is made of a series of barbed ribs and the series of barbed ribs 18 are stacked horizontally along its circumference separated by vertical relief channels. The barbed ribs are configured to expand their outer diameter when the housing is inserted into the mounting retainer. The particulate air outlet is a barbed connection.

In embodiments the blind hole remote sampling point apparatus further comprises a face with a recessed portion to allow a mechanical coupling of an insert and an orifice to allow fluid flow. The insert may be a thin film circuit or alternately it may be injection molded. The inlet is an orifice that is chamfered and sized according to results of a calculation program used to validate design and performance of a particle detection system.

In embodiments the housing has tabs that mechanically couple to receptacles on the mounting retainer allowing the housing to twist lock in place. The face has ribbing around the perimeter and the face may have a chamfered hole.

In accordance with embodiments of the present disclosure, A method of blind hole remote sampling that comprises using a housing with a channel for fluid flow, with a mounting retainer; a particulate air outlet, and an RFID device and mechanically coupling the sampling point housing to the retainer for mounting to a structure. The method configures an RFID device to monitor performance characteristics of the blind hole remote sampling point. The method incorporates barbed ribs on the mounting retainer. The method further comprises stacking the series of barbed ribs horizontally along its circumference and separating them by vertical relief channels. The method also comprises configuring that the barbed ribs are to expand their outer diameter when inserting the housing into the mounting retainer.

In embodiments the method also comprises connecting to the particulate air outlet using a barbed connection. The method further comprises recessing a portion of a face to allow mechanically coupling an insert and an orifice allowing fluid flow. The insert may be made out of thin film or may be injection molded.

### BRIEF DESCRIPTION OF DRAWINGS

These and other features and advantages of the disclosed Blind hole remote sampling point for a particle detector will be more fully understood by reference to the following detailed description in conjunction with the attached drawings in which like reference numerals refer to like elements throughout the different views.

FIG. 1 is a blind hole remote sampling point.

FIG. 2 is a cross section of a blind hole remote sampling point.

FIG. 3 is a face view of a blind hole remote sampling point.

FIG. 4 is a mounting retainer.

FIG. 5 is a mounting retainer cross section.

FIG. 6 is the mounting retainer of FIG. 4 showing a group of barbed ribs.

FIG. 7 is a face view of a mounting retainer.

FIG. 8 is a drawing showing a remote sampling point assembly mounted in a through-hole in a mounting structure such as a ceiling.

FIG. 9 is an assembly drawing showing a remote sampling point with a mounting retainer.

FIG. 10 is a cross section view of a label version of a sampling hole for a remote sampling point with integrated RFID technology.

FIG. 11 is an injection molded insert version of a sampling hole for a remote sampling point.

FIG. 12 is a cross section view of an injection molded insert version of a sampling hole for a remote sampling point.

### DETAILED DESCRIPTION

The blind hole remote sampling point for a particle detector is an all in one remote sample point with integrated RFID technology for storage of data relevant to the remote sample point. It is comprised of two parts to form a compression fit eliminating the need of secondary hardware, making it suitable for practically any mounting structure thickness and blind holes where access to the backside of a mounting structure is inaccessible. The integrated RFID chip permanently stores information electronically. It provides a convenient method for documenting and retrieving information related to the remote sampling point. Parameters such as hole size, a custom name, associated detector location, calculated performance, commissioning benchmark data and subsequent test and inspection data may be stored and easily retrieved. Stored data can be interrogated and telemetered via a radio frequency (RF) interface, such as Near Field Communications (NFC).

In the following description the figures are presented individually, however it may be of greater value to review the figures together as one proceeds through the description.

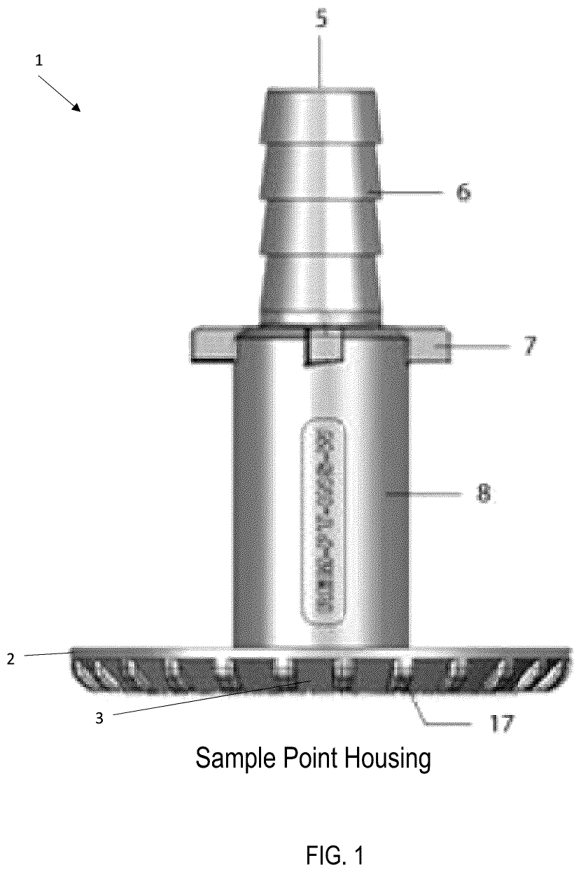

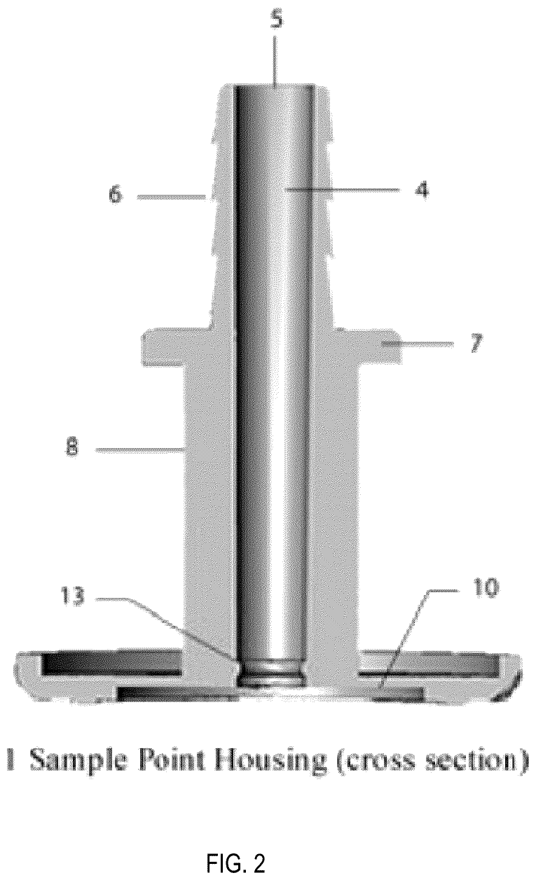

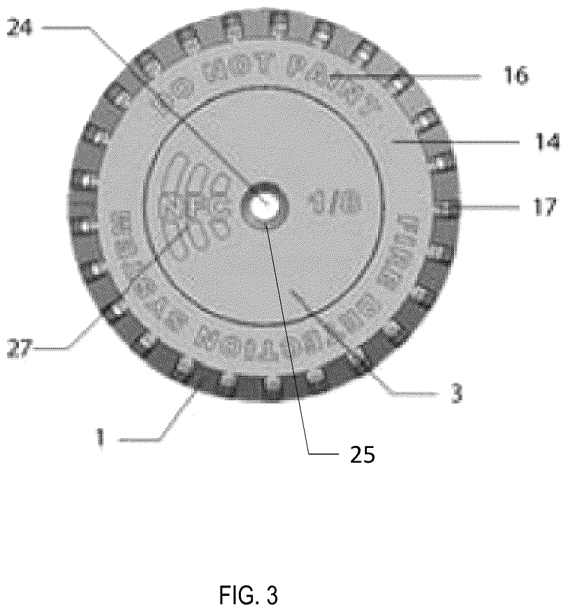

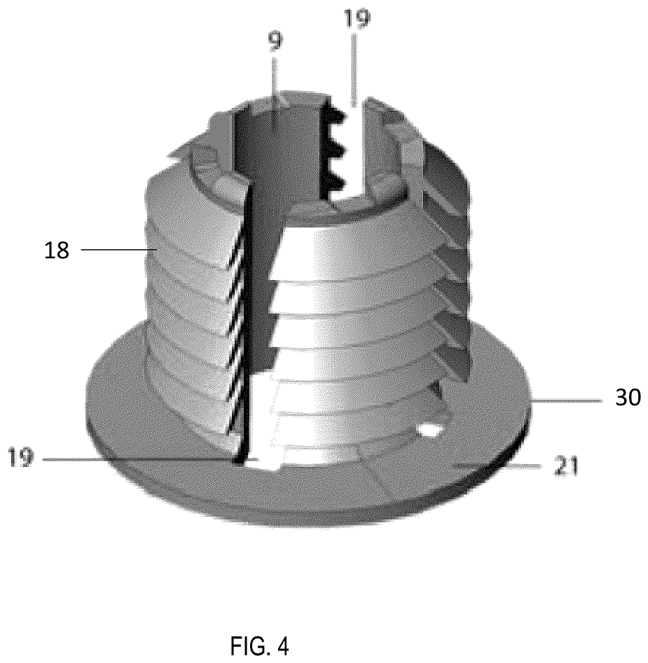

FIG. 1 is a blind hole remote sampling point. The blind hole remote sampling point includes a sample point housing 1, and in an embodiment, insert 3 (FIG. 3). The sampling point housing 1 includes a channel 4 (FIG. 2) for transporting air samples from an ambient environment and an outlet 5 having a barbed outer structure 6 for securing an interconnecting air transport tube for delivery of particles to a particle detector. One or more tabs 7 secures and unsecures the sampling point housing 1 to a mating mounting retainer 30 (FIG. 4). A body section 8 having an outside diameter sized to engage with the inside diameter 9 (FIG. 4) of a mating mounting retainer 30 (FIG. 4). The sampling point housing has ribs 17 (FIG. 3) along the perimeter of the sampling point housing 1 face to aid in installation and removal of the sampling point housing 1 in a mounting retainer 30 (FIG. 4). The sample housing can be made of ABS or another suitable material.

FIG. 2 is a cross section of a blind hole remote sampling point. The sampling point housing 1 includes a channel 4 for transporting air samples from an ambient environment. In one embodiment it also includes a method 13 to secure the insert 3 to the sampling point housing 1. In the embodiment there is a recessed portion 10 that accepts an insert. There is an area on the remote sampling point body where an RFID tag containing an RFID chip and antenna in the form of a label can be easily placed.

FIG. 3 is a face view of a blind hole remote sampling point. FIG. 3 shows in an embodiment an insert 3. It shows ribbing 17 along the perimeter of the sampling point housing face 14 to aid in installation and removal of the sampling point housing. There is an area 16 on the face 14 of the sampling point housing 1 for text and graphics. Also shown is an orifice 24 sized according to results of a calculation program used to validate design and performance of a particle detection system. In one embodiment there is a chamfer 25 at the inlet of the orifice 24 to mitigate contamination from building up around the orifice 24. A chamfered hole is less likely to retain debris than a hole with straight edges. A chamfered hole provides a smooth entry into the hole. Chamfering eliminates sharp edges and burrs (roughness). Debris buildup on sampling orifices of a particle detection systems affects performance as the orifices are engineered sizes. Buildup could reduce the orifice size over time, or if totally blocked could restrict air from entering the sample hole altogether. There is also an area 27 for text, graphics, orifice size, part number, bar and/or QR codes. In a preferred embodiment the insert 3 can be fabricated with ABS. It can also be fabricated with a variety of materials.

FIG. 4 is a mounting retainer 30. The mounting retainer 30 includes: a series of barbed ribs 18 stacked horizontally along its circumference separated by vertical relief channels 19; a flange 21 having a larger diameter than the major diameter of the barbed ribs 18 with an inner diameter 9. The retainer 30 can be fabricated using ABS or a variety of other materials.

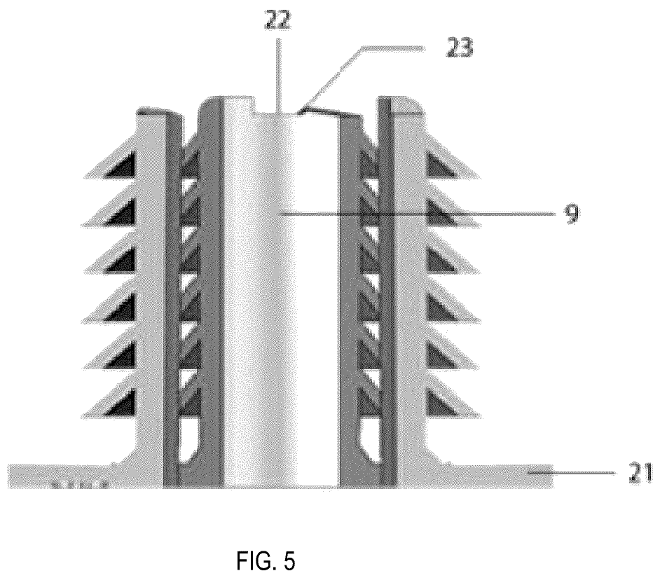

FIG. 5 is a mounting retainer cross section. It shows inner diameter 9, a flange 21, one or more receptacles 22 to interface with tabs 7 on a sampling point housing 1 to secure and unsecure the sampling point housing 1 to mounting retainer 30, including a feature 23 to provide feedback when secured. Feature 23 helps keep the sampling point housing secured by creating a ledge in which the tabs cannot easily reverse out of. The ledge also acts to provide feedback when the sampling point housing is rotated to the secured (locked) position.

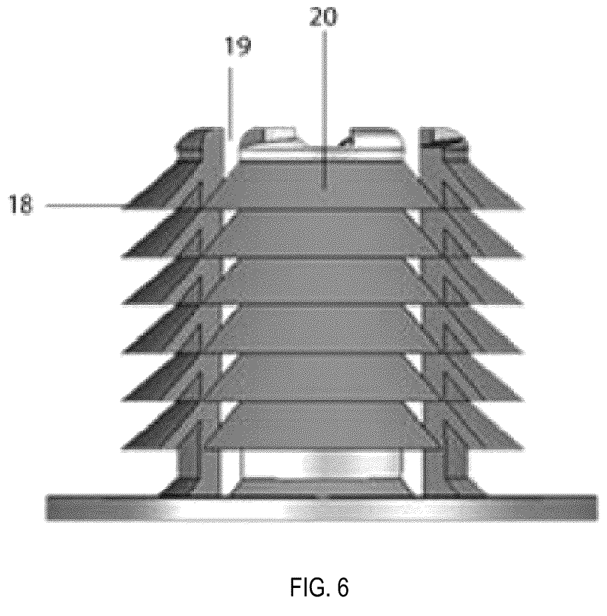

FIG. 6 is a mounting retainer of FIG. 4 showing a group of ribs. It shows a series of barbed ribs 18 stacked horizontally along its circumference separated by vertical relief channels 19 along with barbed rib sections 20 to flex inward or outward. The sections of ribs will flex outward when sampling point housing 1 is inserted and flex inward when sampling point housing 1 is removed. The outward flex is what causes the compression against the through-hole in the mounting structure. The inward flex is what aids in the removal of the insert if removing the assembly from the mounting structure.

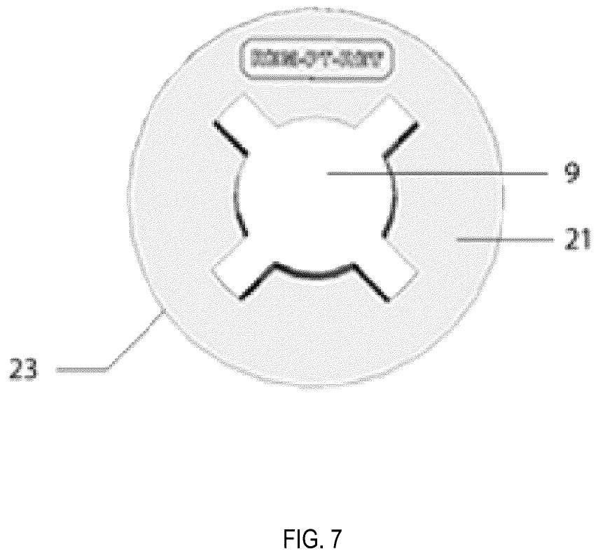

FIG. 7 is a face view of a mounting retainer. It shows an inner diameter 9 and a flange 21 having a larger diameter than the major diameter of the barbed ribs 18 (FIG. 6) to limit insertion distance of the mounting retainer 30 into a through-hole in a mounting structure.

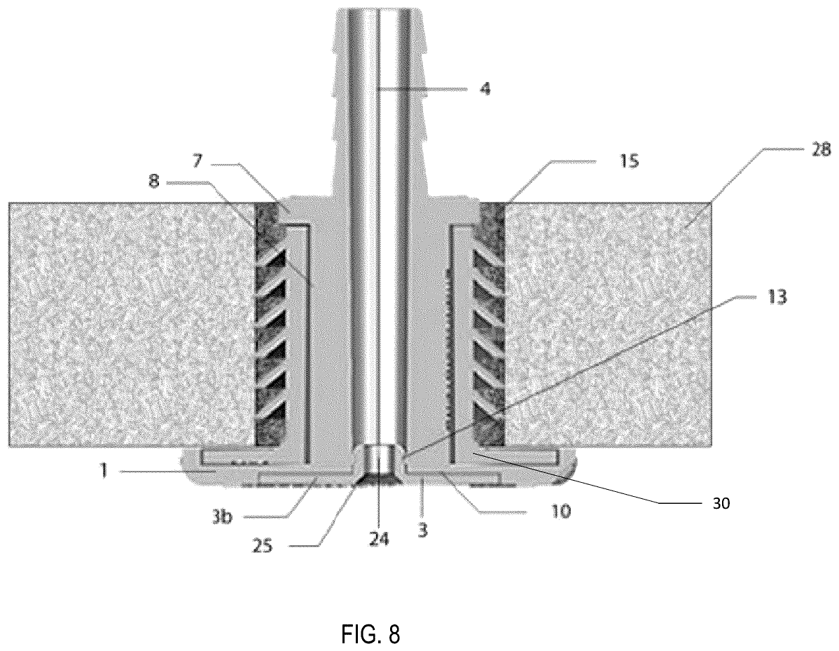

FIG. 8 is a drawing showing a remote sampling point housing mounted in a through-hole in a mounting structure such as a ceiling. The mounting retainer inserts into a through-hole 15 drilled into the mounting structure 28 such as a ceiling. The major diameter of the barbed ribs 18 on the mounting retainer 30 is slightly larger than the through-hole 15 drilled into the mounting structure 28. Vertical reliefs 19 in the mounting retainer 30 allow groups of barbed rib sections 20 to flex inward during insertion, allowing insertion and removal of the mounting retainer 30 within the through-hole 15 of the mounting structure 28. The vertical reliefs allow groups of barbed ribs to flex outward when the sample point housing 1 is inserted. In this example four groups are shown but there may be less groups or more groups in embodiments. The ribs create the compression needed to retain the assembly within the through-hole it is inserted. If there were no relief channels the barbed ribs would be interconnected around the circumference of the mounting retainer 30 with no way for them to move inward or outward. If that were the case the receiving through-hole would need to be much smaller than the circumference of the barbed ribs to get the compression needed to hold the assembly firmly in place, and the assembly could not be easily removed without damaging the assembly or the structure to which it is mounted.

The sampling point housing 1 includes a body section 8 having an outside diameter near a net fit with the inside diameter 9 of the mounting retainer 30, such that when it is inserted into the mounting retainer 30 it causes the groups of barbed structures 20 of the mounting retainer 30 to flex outward, compressing against and digging into the walls of the through-hole 15 in the mounting structure 28 so that it firmly anchors in place. Once fully inserted, the sampling point housing 1 is then locked into place by rotating causing tabs 7 on the sampling point housing 1 to interlock with receptacles 22 in the mounting retainer 30. In addition there is a locking feature 23. In this way the housing can twist lock into the mounting retainer. This method does not require access to or anchoring onto the backside of the mounting structure 28, thus making it suitable for blind hole application on mounting structures 28 of any thickness. Rotating the sample point housing 1 an opposite direction allows it to be removed in the manner that it was inserted, thus the assembly can be removed when required without damaging the sample point assembly or the mounting structure 28. Other means of interlocking the sample point housing 1 to the mounting retainer 30 are possible. The face 14 of the sample point housing 1 is provided with ribs 17 along its perimeter for texture to aid in the rotation for assembly and disassembly. Insert 3 in an embodiment is mounted into receptacle 10 along with an RFID tag 3b, which can be in the form of a label. Particulate in the sampled air is transported via orifice 24 with a chamfer 25 and is in fluid contact with the channel made by the inner diameter 4, through a tube interconnected between outlet 5 and a particle detection system sample pipe network

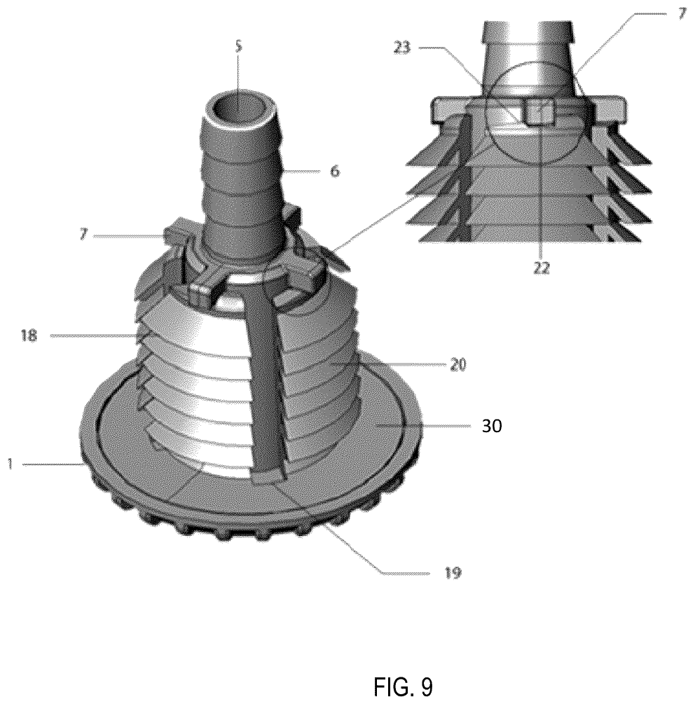

FIG. 9 is an assembly drawing showing a remote sample point with a mounting retainer. It shows the tabs 7 and receptacles 22 that are used to interlock the sampling point housing 1 with the mounting retainer 30. It has a hose attachment 5 that includes barbed ribs 6. The barbed ribs 6 secure the interconnecting tubing and create a leak proof connection. External barbed ribs 18 anchor the assembly in place in a through-hole in the mounting structure. Vertical relief channels 19 along with barbed rib sections 20 make it possible to flex freely inward or outward. Groups of barbed ribs 20 expand outward as the sampling point housing 1 is inserted into the mounting retainer 30. The groups of barbed ribs 18 flex inward when the sampling point housing 1 is removed so that the mounting retainer 30 can be easily removed from the mounting structure.

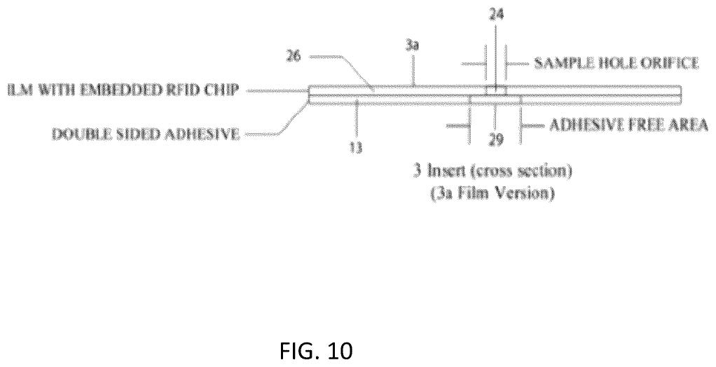

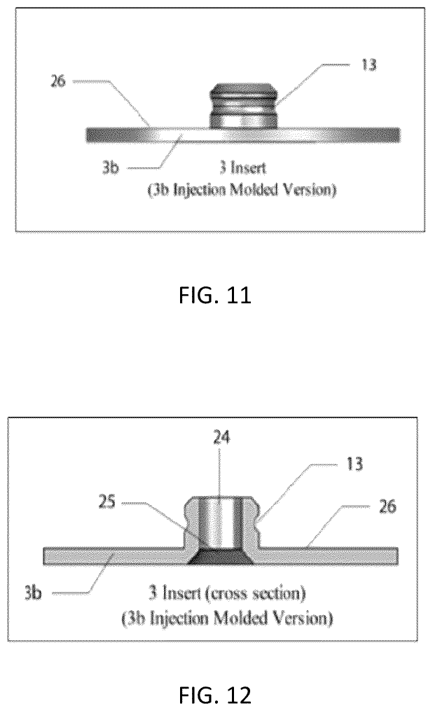

FIG. 10 is a cross section view of a label version of a sampling hole for a remote sampling point with integrated RFID technology. The insert, which can be a film 3a or an injection molded structure 3b includes; an orifice 24 sized according to results of a calculation program used to validate design and performance of a particle detection system; an RFID device 26, such as an NFC tag which includes an RFID chip and related antenna in the form of a label. The film 3a can be a material such as PET or metal with adhesive backing, applied in the form of a label The tag could also be injection molded in variant 3b shown in FIG. 11 and FIG. 12. The RFID device stores and manages data relevant to the remote sampling point, such as orifice size, installation date, benchmark commissioning data, inspection testing data, associated detector, associated location and other installation, service and performance related details; an area 27 for text, graphics, orifice size, part number, bar and/or QR codes. It stores data dynamically so that updates are stored such as updates to performance related details. The retaining method could be by a variety of means, such as a ribbed boss, threads, tabs, etc.

In operation the flow rate of ambient air back to a particle detector is managed by an orifice sized according to results from the particle detection system's flow calculation program. In an embodiment a self-adhesive film 3a of insert 3 is provided, having an appropriately sized orifice 24 intended to adhere within a recess 10 provided in the face 14 of the sampling point housing 1, covering the larger channel 4 in the sampling point housing 1. In embodiments the film could also be a rigid structure, such as a thin metal or thermoplastic disc having adhesive on one side. The film 3a includes an area 29 intended to keep particulate from building up on the adhesive 13 passing through the orifice 24. The film 3a contains an area 27 on its face for printed text and graphics. The film 3a insert 3 may have an integrated RFID chip and antenna 26 for providing a means to electronically identify and manage the remote sampling point. The insert 3 may be injection molded.

FIG. 11 is an injection molded insert version of a sampling hole for a remote sampling point. FIG. 12 is a cross-section view of an injection molded insert version of a sampling hole. Shown in FIGS. 11 and 12, 3b is an injection molded insert 3. It has an appropriately sized orifice 24 with a chamfered inlet 25 intended to snap into and be retained by interlocking features 13 is molded into the insert 3 and channel 4 of the sampling point housing 1. The injection molded 3b insert 3 contains an area 27 on its face for text and graphics. The injected molded 3b insert 3 may have an integrated RFID chip and antenna 26, for providing a means to electronically identify and manage the remote sampling point. It can be appreciated that there are other means of securing the insert 3 to the sampling point housing 1. The insert 3 in another embodiment can be omitted, in which case the orifice 24 with chamfered inlet 25 could be injection molded into the sample point housing 1 as a single piece and an RFID chip and antenna 26 integrated on or within the sampling point housing 1. For each of the embodiments mentioned, the approach of using an insert or molded preformed orifice eliminates field technicians from drilling orifices in the field, mitigating risks and challenges attributed with hand drilling orifices, such as incorrect size, steadiness, burrs, variations in angles, etc.

It should be appreciated that RFID technology includes all types of RFID systems, such as ultra-high frequency (UHF), high frequency (HF), near field communication (NFC), low frequency (LF), etc. It should also be appreciated that integration of RFID technology could be by any means, such as over molding by injection molding, RFID labels, etc. A custom mobile device application can be used to interface the device. With a custom application on an Android or IOS device, users can read a tag affixed or embedded on a sample point. This is not limited to cell phone application but may be used with any processor that is RFID enabled running an appropriate application. The tag contains a unique identifier in permanent memory and a custom text string in writable memory. The custom text string tells the app what type of sample point is being read and hole size. If the RFID tag has not been written to the app database, the user is prompted to add the tag which is considered the tags commissioning process, where the user can provide a custom name for the tag, associate it to a particular location and detector, and input performance criteria associated with the sample point. Once saved, the data is written to the database associated to the tags UID. Once added, future reading of the tag will display stored information related to the tag, such as inspection due dates, past inspection results, commissioning results, commissioning agent, commissioning date, etc. Historical data can be used by the applications resident on any processing system to predict performance trends using analytical data.

NFC chips include a unique ID (UID) or serial number. The smart chip also includes on-board memory where an identifier is written in the form of text to define if the tag is a benchmark test point or a sample point, type of sample point, and orifice size. A custom app is used on a mobile device, such as IOS or Android, to read data of the tag embedded in the sample point. The app allows the user to assign the tag to a physical location and specific air sampling detector, record performance characteristics associated with the sample point and perform subsequent inspections to monitor the status of an air sampling detection system. Tag data is stored in the cloud and retrieved by the custom app. Users can retrieve the information on a cell phone or other processing device.

What is claimed is:

1. A blind hole remote sampling point apparatus comprising:
a housing with a channel for fluid flow;
a mounting retainer;
a particulate air outlet;
an air inlet;
an RFID device;
wherein the sampling point housing mechanically couples to the retainer for mounting to a structure;
the RFID device configured to monitor performance characteristics of the blind hole remote sampling point.

2. The apparatus of claim 1 wherein the mounting retainer is made of a series of barbed ribs.

3. The apparatus of claim 2 wherein the series of barbed ribs 18 are stacked horizontally along its circumference separated by vertical relief channels.

4. The apparatus of claim 3 wherein the barbed ribs are configured to expand their outer diameter when the housing is inserted into the mounting retainer.

5. The apparatus of claim 1 wherein the particulate air outlet is a barbed connection.

6. The apparatus of claim 1 further comprising a face with a recessed portion to allow a mechanical coupling of an insert and an orifice to allow fluid flow.

7. The apparatus of claim 6 wherein the insert is a thin film circuit.

8. The apparatus of claim 6 wherein the insert is injection molded.

9. The apparatus of claim 1 wherein the inlet is an orifice that is chamfered and sized according to results of a calculation program used to validate design and performance of a particle detection system.

10. The apparatus of claim 1 wherein the housing has tabs that mechanically couple to receptacles on the mounting retainer allowing the housing to twist lock in place.

11. The apparatus of claim 1 wherein the face has ribbing around the perimeter.

12. The apparatus of claim 1 wherein the inlet is a chamfered hole.

13. A method of blind hole remote sampling comprising:
using a housing with a channel for fluid flow, with a mounting retainer; a particulate air outlet, and an RFID device;
mechanically coupling the sampling point housing to the retainer for mounting to a structure;
configuring an RFID device to monitor performance characteristics of the blind hole remote sampling point.

14. The method of claim 13 comprising incorporating barbed ribs on the mounting retainer.

15. The method of claim 14 comprising stacking the series of barbed ribs horizontally along its circumference and separating them by vertical relief channels.

16. The method of claim 15 wherein configuring the barbed ribs to expand their outer diameter when inserting the housing into the mounting retainer.

17. The method of claim 13 wherein connecting to the particulate air outlet using a barbed connection.

18. The method of claim 13 further comprising recessing a portion of a face to allow mechanically coupling an insert and an orifice allowing fluid flow.

19. The method of claim 18 comprising making the insert out of thin film.

20. The method of claim 18 comprising making the insert using injection molding.
